(19) United States
(12) Patent Application Publication
(10) Pub. No.: US 2015/0343369 A1
(43) Pub. Date: Dec. 3, 2015

(54) PROCESS FOR RECOVERING CARBON DIOXIDE FROM CONSTRUCTION EXHAUST GAS

(71) Applicant: TOYO ENGINEERING CORPORATION, Tokyo (JP)

(72) Inventor: Yasuhiko Kojima, Chiba (JP)

(73) Assignee: TOYO ENGINEERING CORPORATION, TOKYO (JP)

(21) Appl. No.: 14/759,650

(22) PCT Filed: Jan. 28, 2014
(86) PCT No.: PCT/JP2014/000410

§ 371 Date: Jul. 7, 2015

(30) Foreign Application Priority Data
Feb. 8, 2013 (JP) 2013-023524

(51) Int. Cl. B01D 53/14

(52) U.S. Cl. CPC B01D 53/1475; B01D 2252/204

(57) ABSTRACT

In a chemical plant 100 including a carbon dioxide recovery unit 10 and a urea plant 11, the carbon dioxide recovery unit 10 treats combustion exhaust gas from a boiler B to separate and recover carbon dioxide. Low-pressure steam 33 generated in the urea plant 11 is supplied to the carbon dioxide recovery unit 10 as a heat source for its regeneration tower reboiler. Carbon dioxide 22 recovered in the carbon dioxide recovery unit 10 is sent to an EOR facility, a storage facility, and the like outside the plant. Thus, the low-pressure steam generated in the urea plant 11 is effectively used as a heat source for the carbon dioxide recovery unit 10.

### TECHNICAL FIELD

The present invention relates to a process for recovering carbon dioxide from combustion exhaust gas discharged from a thermal power plant, a chemical plant, and the like. In particular, the present invention relates to a process, which can suitably supply a heat source for the carbon dioxide recovery unit where a carbon dioxide recovery unit is installed to absorb carbon dioxide contained in combustion exhaust gas produced by combustion of carbon-containing fuels, such as fossil fuels, into an absorbing solution.

### BACKGROUND ART

Conventionally, greenhouse effect due to carbon dioxide present in combustion exhaust gas produced by combustion of fossil fuels has been pointed to as one of the causes of global warming. To address this issue, there have been global efforts toward the reduction of the greenhouse gas emissions. Among many emission sources of combustion exhaust gas, thermal power plants, and the like, which use large quantities of fossil fuels account for a large proportion of the emissions. Studies are therefore underway on technologies for separation and recovery of carbon dioxide from combustion exhaust gas, and there are many proposals of methods for utilizing and storing recovered carbon dioxide without releasing it into the atmosphere.

One of the particularly promising technologies for separation and recovery of carbon dioxide from combustion exhaust gas of a power plant is a method involving installation of a carbon dioxide recovery unit which utilizes an absorbent (absorbing solution) in a combustion exhaust gas line. FIG. 5 schematically shows this carbon dioxide recovery unit. A carbon dioxide recovery unit 10 includes: an absorption tower 1 which absorbs carbon dioxide into an absorbing solution (e.g., an absorbing solution of amine compounds such as MEA); and a reboiler 3 which separates and recovers, in a regeneration tower 2, the carbon dioxide present in the absorbing solution from the absorption tower, circulates the regenerated absorbing solution to the absorption tower, and supplies vapor to the regeneration tower. This carbon dioxide recovery unit absorbs carbon dioxide present in combustion exhaust gas into the absorbing solution in the absorption tower 1, heats the absorbing solution containing the absorbed carbon dioxide (rich solution) in the regeneration tower 2 to release the carbon dioxide gas from the rich solution as well as to regenerate the absorbing solution by supplying a heat source through the reboiler connected to the regeneration tower 2, and returns the absorbing solution regenerated in the regeneration tower 2 (lean solution) to the absorption tower so as to circulate the absorbing solution within the unit.

One of the problems faced by the carbon dioxide recovery process which adopts the carbon dioxide recovery unit as described above is the heat supply to the reboiler for regenerating the absorbing solution having absorbed carbon dioxide. For example, in a thermal power plant, it is possible to extract low-pressure steam from a power generation steam turbine for the use as a heat source for the regeneration tower reboiler. This is due to the fact that, although low-pressure steam (0.1 to 1.0 MPaG) is suitable as a heat source for the regeneration tower reboiler, most thermal power plants have no boiler for generating low-pressure steam (Patent Literature 1, Non Patent Literature 1).

### PRIOR ART DOCUMENTS

### Patent Literature

### [Patent Literature 1]

Japanese Patent Application Laid-Open No. 2011-132899

### Non Patent Literature

### [Non Patent Literature 1]

Hideo Kitamura, Norihide Egami, Yukio Ohashi, “Validation Testing of Carbon Dioxide Capture Pilot Plant Using Flue Gas of Coal-Fired Thermal Power Plant”, Toshiba Review, Vol. 65, No. 8 (2010), P31-34.

### SUMMARY OF INVENTION

### Problems to be Solved by the Invention

However, if low-pressure steam is to be extracted from the existing power generating steam turbine, as extensive modification of the steam turbine is required and, in some cases, replacement of the steam turbine itself is necessary, the modification cost becomes a concern. In addition, even if modification of the existing facility is implemented, reduction in output, namely reduction in generated power, of the power generation steam turbine due to extraction of low-pressure steam is unavoidable. Since compensating for the reduction in generated power requires additional power generation facilities for covering the reduction or purchase of power from the outside, the power generation efficiency of the power plant consequently decreases.

Another possible option is to install a new boiler for generating low-pressure steam suitable for the regeneration tower reboiler, which naturally requires an enormous construction cost. In addition, new construction of a boiler is least efficient in terms of carbon dioxide emission reduction energy penalty (energy for which a target plant consumes to reduce a certain unit amount of carbon dioxide).

While the above is a problem in installing the carbon dioxide recovery unit in a thermal power plant, a similar problem exists in a chemical plant. Also in a chemical plant, a boiler for generating a heat source for various plant components or steam used as raw materials of chemicals, a reforming furnace for steam reformer, and the like, and a heating furnace, and the like are installed, and in most cases these components also combust fossil fuels and discharge combustion exhaust gas.

Thus, although installation of the carbon dioxide recovery unit is desirable also in a chemical plant, the existing boiler in the chemical plant is not originally designed with extra capacity. For this reason, it is not always possible to additionally generate a sufficient amount of steam from the existing boiler to allow for installation of the carbon dioxide recovery unit. Accordingly, there is a need also in the chemical plant to consider enhancing the capacity of the existing boiler or constructing a new boiler.

Devised against this background, the present invention provides a process for recovering carbon dioxide from combustion exhaust gas, which utilizes the above-described absorbing solution circulation-type carbon dioxide recovery unit and can efficiently supply a heat source to a regeneration tower reboiler. In particular, the present invention provides a process which allows for installation of the carbon dioxide recovery unit in an existing plant with little burden.

### Means for Solving the Problems

The present invention for solving the above problems is a process for recovering carbon dioxide in a plant which includes: at least one combustion unit combusting a fuel or mixture of fuels; combustion exhaust gas line(s) for combustion exhaust gas from the combustion unit to flow through; and a carbon dioxide recovery unit installed in the combustion exhaust gas line(s). The carbon dioxide recovery unit includes: absorption tower(s) wherein carbon dioxide is absorbed into an absorbing solution (e.g., absorbing solution of amine compounds); regeneration tower(s) wherein the absorbing solution is regenerated by separating and recovering the carbon dioxide present in the absorbing solution; and a reboiler which supplies vapor to the regeneration tower from which the regenerated absorbing solution is sent to the absorption tower. The plant includes at least one plant component which discharges low-pressure steam at a pressure of 0.1 to 1.0 MPaG, and a line is installed for supplying the low-pressure steam as a heat source from the plant component to the regeneration tower reboiler of the carbon dioxide recovery unit.

In order to solve the above problems, the present inventors focused on the low-pressure steam discharged from a given plant component constituting a chemical plant (specific plant components will be detailed later) and the possibility of utilizing the low-pressure steam as a supply source of a heat source for the regeneration tower reboiler of the carbon dioxide recovery unit. The low-pressure steam from this given plant component is at a pressure in a range of 0.1 to 1.0 MPaG (temperature of 120° C. or higher), and has adequate temperature and energy as a heat source for the regeneration tower reboiler of the carbon dioxide recovery unit. The present invention takes full advantage of the energy of this low-pressure steam in order to avoid a cost increase due to construction of a new boiler and an increase in the carbon dioxide emission reduction energy penalty.

The technical significance of the present invention which utilizes the low-pressure steam from the existing plant component is that not only the construction of a new boiler can be avoided but also the low-pressure steam can be more effectively utilized than it has been in conventional forms of utilization. More specifically, in the conventional plant operation, one of the most common forms of utilization of the low-pressure steam discharged from a plant component is to admit it into the steam turbine(s) installed in the plant. Typically installed in a plant is compressor(s) for pressure regulation of various process fluids, and the steam turbine(s) (high-pressure turbine) is/are also installed to drive the compressor. The low-pressure steam discharged from each plant component is admitted into the steam turbine along with high-pressure steam to be supplied to the steam turbine. However, only about 10 to 20% of the energy possessed by the low-pressure steam admitted into the steam turbine(s) is/are utilized as the output for the turbine. As the low-pressure steam is condensed into water in a condenser at the exhaust of the turbine, the remaining 80 to 90% of the energy is lost into cooling media of the condenser. In contrast, according to the present invention, which utilizes the low-pressure steam from the existing plant component as a heat source for the regeneration tower reboiler, the utilization efficiency of energy is increased, and energy loss of the low-pressure steam can be significantly reduced compared with the conventional process.

In the present invention, a plant component refers to an area which is constituted of multiple pieces of equipment each receiving specified raw materials and utilities to produce, reform chemicals, and which can provide a heat source and the like besides the product according to its purpose. In the present invention, a urea plant comes up first as a plant component which discharges low-pressure steam (provides a heat source) suitable as a source for the regeneration tower reboiler.

The urea plant is a plant component which is mainly constituted of: a reactor which reacts ammonia and carbon dioxide as raw materials; a stripper which separates mixture gas containing unreacted ammonia and unreacted carbon dioxide from a urea synthesis solution produced in the reactor (a urea synthesis solution composed of urea, unreacted ammonia and unreacted carbon dioxide, and water); and a condenser which condenses a gas mixture from the stripper with an absorbing medium to obtain condensate. The condensate resulting from condensation in the condenser is sent to the reactor.

In this type of urea plant, boiler water is typically introduced as a cooling medium for condensing the gas mixture in the condenser, and this boiler water is heated to be boiled and discharged as a mixture of low-pressure steam and saturated water. Generally, this low-pressure steam is at a pressure in a range of 0.1 to 0.7 MPaG (G means gauge pressure) and at a temperature in a range of 120 to 170° C., which can be suitable as a heat source for the regeneration tower reboiler.

As the carbon dioxide used as a raw material for urea production, the carbon dioxide generated in an ammonia plant which is usually co-installed to the urea plant is used, and this carbon dioxide is pressurized by the compressor before being supplied to the urea plant. Thus, a compressor and a steam turbine for driving the compressor are commonly installed for the urea plant. For this reason, it has been a common practice to admit the low-pressure steam discharged from the urea plant into the steam turbine. Although this practice is not efficient as described above, the present invention can eliminate the energy loss.

Other plant components suitable as a low-pressure steam supply source include plants for ammonia, methanol, dimethyl ether (DME), or the like. This is because these plant components are also capable of generating low-pressure steam as with the urea plant. In the present invention, the plant component serving as a low-pressure steam supply source may be installed as a single unit, or multiple plant components may be appropriately combined.

The above-described conventional carbon dioxide recovery unit can be adopted as the one to be installed in the combustion exhaust gas line. The unit configuration is not particularly limited, however, as long as a carbon dioxide absorption tower using an absorbing solution and a regeneration tower are appropriately combined and a reboiler is included which supplies heat to the regeneration tower for regenerating the absorbing solution. Of course, the type of the absorbing solution and the like is also not limited.

The combustion unit covered by the present invention is combustion units in general, which combust carbon-containing fuels to generate thermal energy while discharging combustion exhaust gas containing carbon dioxide. Examples include a steam boiler, a reforming furnace for steam reforming, and the like, and a heating furnace in a plant such as a chemical plant and an oil refinery plant. Combustion exhaust gas from boilers (high-pressure, intermediate-pressure, and low-pressure boilers) of a power plant such as a thermal power plant may also be included. For example, the process of the present invention may be implemented in combination with a plant component such as a chemical plant which can supply low-pressure steam to a power plant through a pipeline.

The concentration of carbon dioxide present in combustion exhaust gas is substantially reduced by the carbon dioxide recovery unit before the combustion exhaust gas is released into the atmosphere. On the other hand, carbon dioxide recovered via the carbon dioxide recovery unit is commonly high-purity carbon dioxide with a purity of 99% or higher and reusable. Recently, as part of countermeasures against global warming, efforts have been made to recover as well as store carbon dioxide (CCS: Carbon dioxide Capture and Sequestration). In this connection, the process according to the present invention also proposes efficient use and storage of recovered carbon dioxide.

First, high-purity carbon dioxide recovered by the carbon dioxide recovery unit serves as raw materials for various chemicals by being supplied to raw material supply lines of the plant components. For example, in the urea plant which is suitable as a heat source for the regeneration tower reboiler of the carbon dioxide recovery unit, along with ammonia, high-purity carbon dioxide is supplied as a raw material. Thus, it is possible to reuse the carbon dioxide recovered in the carbon dioxide recovery unit by supplying the whole or part of it to a raw material supply line of the urea plant (specifically, a supply line at a front stage of the compressor).

In addition, carbon dioxide is supplied as a raw material also in a methanol plant, a dimethyl ether plant, and a steam reformer (including a so-called dry reforming method using carbon dioxide as a reforming agent). Therefore, in a case where these plant components are installed inside the plant, the whole or part of the carbon dioxide from the carbon dioxide recovery unit can be supplied to the raw material carbon dioxide supply line of these plant components.

Meanwhile, enhanced oil recovery (EOR) is attracting attentions as a form of utilization of carbon dioxide. EOR is a technology of injecting high-pressure carbon dioxide gas (and water) into an oil reservoir to improve the oil recovery rate. In the carbon dioxide recovery process according to the present invention, the whole or part of the recovered carbon dioxide can be effectively utilized by means of installing a transport or storage line from the recovery unit to an EOR facility. In EOR, the injected carbon dioxide gas partly remains in the ground, while the rest of the carbon dioxide gas is returned to the surface, together with the produced oil, and the returned carbon dioxide can be recovered and injected into the ground again. Through repetition of this cycle, eventually a large part of the carbon dioxide can be permanently stored and isolated in the ground.

On the other hand, carbon dioxide storage is a technology of isolating and storing carbon dioxide in the ground or under the sea bed. In the carbon dioxide recovery process according to the present invention, installation of transport means from the recovery unit to the storage facility makes it possible to suppress carbon dioxide emission to atmosphere.

Thus, the recovered carbon dioxide can be effectively utilized by appropriately setting the recovered carbon dioxide line according to the various plant components inside the plant complex or the configuration of the various treatment facilities outside the plant.

It also becomes possible to utilize a given accompanying facility inside the plant as an accompanying facility of multiple plant components, and by integrating these facilities, more efficient utilization of the recovered carbon dioxide and reduction of energy loss can be achieved.

One specific example of the given accompanying facility inside a plant is a compressor. A compressor is commonly installed for the urea plant as mentioned above. This means that at least one compressor is installed in a plant including the urea plant. On the other hand, to utilize and dispose of the carbon dioxide recovered by the process of the present invention, it is in some cases necessary to pressurize the carbon dioxide to a certain pressure or higher. For example, utilizing the carbon dioxide by EOR or storing it in the ground as described above requires the carbon dioxide to be at a high pressure.

For this purpose, the carbon dioxide recovered by the carbon dioxide recovery unit can be supplied to the compressor for the urea plant, and the carbon dioxide can be supplied from this compressor to the urea plant and the carbon dioxide transport line/storage facility. This eliminates the need for newly constructing a compressor for the carbon dioxide transport/storage line.

When there is another plant component inside the plant which requires high-pressure carbon dioxide, the above-described compressor installed for the urea plant can double as the compressor for that plant component. A methanol synthesis unit can be taken as an example. In this case, the compressor installed for the urea plant can supply high-pressure carbon dioxide to the urea plant and the methanol synthesis unit. At the same time, this compressor may supply high-pressure carbon dioxide to the carbon dioxide transport line/storage facility.

Thus, one of the advantages of the compressor installed for the urea plant doubling as a compressor required for another plant component or treatment facility is that facility cost reduction and energy saving can be achieved. This effect is remarkable especially when a recovery amount in the carbon dioxide recovery unit is small. When designing a compressor for a small-capacity (e.g., 800 ton/day or less) carbon dioxide recovery unit, there is no other choice but to adopt a reciprocating compressor which is inferior in reliability and cost efficiency. In contrast, by sharing the compressor installed for the urea plant, a large centrifugal compressor can be adopted, which promises to bring about all of the improved reliability, cost reduction, and energy saving.

### Advantageous Effects of Invention

The carbon dioxide recovery process according to the present invention has reevaluated an existing plant component inside a plant and utilizes it to recover carbon dioxide from combustion exhaust gas. This has made it possible to efficiently utilize the low-pressure steam from the plant component, of which its utilization efficiency has been conventionally low. In addition, the carbon dioxide emission reduction energy penalty has been reduced. The process according to the present invention is not only useful during new plant construction but also especially useful for the existing plant, thus it allows modification at low cost and in a short construction period.

### BRIEF DESCRIPTION OF THE DRAWINGS

FIG. 1 A schematic view illustrating a configuration of a plant of First Embodiment which uses a urea plant as a supply source of low-pressure steam.

FIG. 2 A schematic view illustrating a configuration of a conventional plant having a urea plant.

FIG. 3 A schematic view illustrating a configuration of a plant of Second Embodiment which uses a urea plant as a supply source of low-pressure steam.

FIG. 4 A schematic view illustrating a configuration of another embodiment of Second Embodiment which uses the urea plant as a supply source of low-pressure steam.

FIG. 5 A view illustrating a configuration of a carbon dioxide recovery unit.

### MODE FOR CARRYING OUT THE INVENTION

Embodiments of the present invention will now be described based on the example embodiments described below. Here, as one example, a carbon dioxide recovery process in a plant having a urea plant as a supply source of low-pressure steam will be described.

### First Embodiment

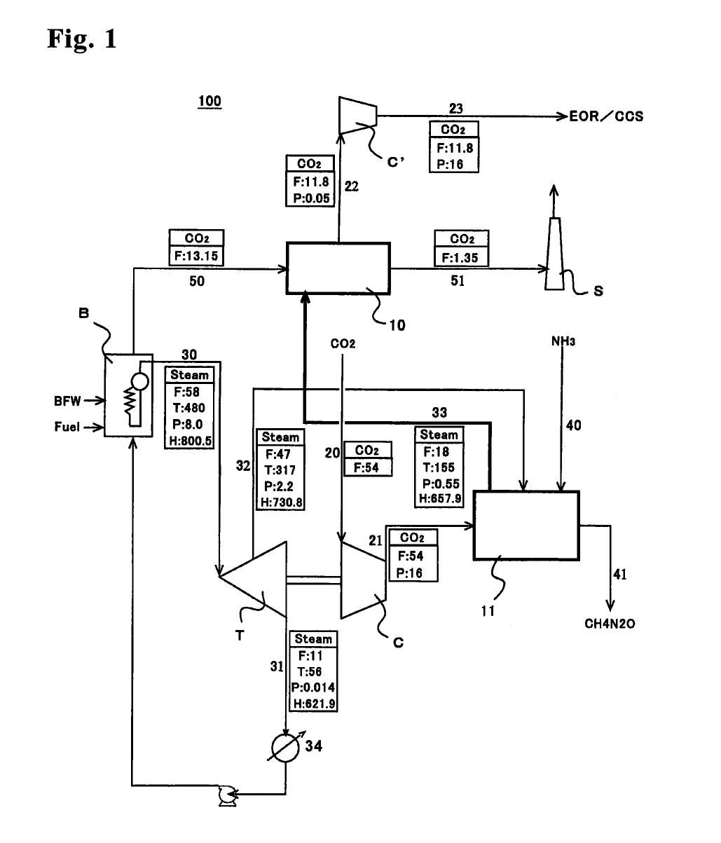

FIG. 1 shows a process flow in a chemical plant 100 which includes a carbon dioxide recovery unit and a urea plant. In FIG. 1, a carbon dioxide recovery unit 10 and a urea plant 11 are shown with fluid names and numerical data such as flow rate described in major lines to indicate the mass balance among the lines connected to each equipment. In this data, the letter F denotes flow rate (ton/h), T denotes temperature (° C.), P denotes pressure (MPa), and H denotes enthalpy (kcal/kg). The urea plant shown in FIG. 1 has a production capacity of 1750 ton/day (73 ton/h), on which the numerical values in each line are based.

In this chemical plant 100, carbon dioxide used as a raw material for the urea plant 11 is supplied from an adjacent ammonia plant (not shown). Carbon dioxide 20 from the ammonia plant is pressurized by a compressor C and supplied to the urea plant 11 through a supply line 21. At the same time, ammonia 40 produced in the ammonia plant is supplied to the urea plant 11. Then, the urea plant 11 performs synthesis and purification of the urea to discharge urea 41.

The compressor C which pressurizes the carbon dioxide 20 from the ammonia plant is driven with a steam turbine T. High-pressure steam 30 for driving the steam turbine T is generated in a boiler B. A fuel and boiler feed water (BFW) are supplied to the boiler B, and the boiler discharges combustion exhaust gas by combustion of the fuel and generates the high-pressure steam. The high-pressure steam 30 generated by the boiler B is supplied to a steam turbine T to drive the steam turbine before being discharged (31), and thereafter cooled and condensed by a condenser (34) and circulated to the boiler B. Intermediate-pressure steam 32 is extracted from the steam turbine T and supplied to the urea plant 11. This intermediate-pressure steam 32 is supplied to a stripper (not shown) of the urea plant 11.

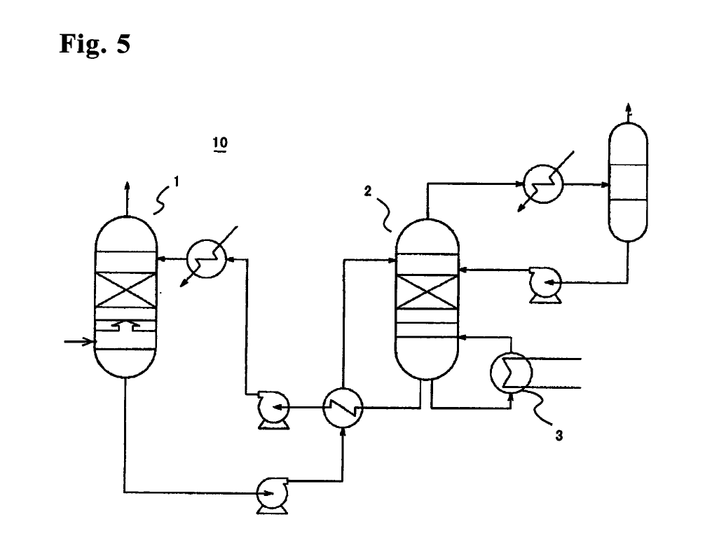

The combustion exhaust gas from the boiler B passes through a combustion exhaust gas line 50. In the combustion exhaust gas line 50, the carbon dioxide recovery unit 10 is installed, where the combustion exhaust gas is treated for separation and recovery of carbon dioxide. The carbon dioxide recovery unit 10 has the same configuration and the recovery process as the carbon dioxide recovery unit in FIG. 5. The present embodiment assumes that the recovery rate of the carbon dioxide recovery unit is about 90%.

The carbon dioxide 22 recovered in the carbon dioxide recovery unit 10 is pressurized by a compressor C′. Pressurized carbon dioxide 23 is sent via a pipeline (not shown) for transport and storage to an EOR facility and a storage facility outside the plant. Combustion exhaust gas 51 after the carbon dioxide recovery treatment is released into the atmosphere from a stack S with a reduced content of carbon dioxide.

In the present embodiment, low-pressure steam 33 generated by the urea plant 11 (specifically, generated by the condenser (not shown)) is supplied to the carbon dioxide recovery unit 10. More specifically, the low-pressure steam is supplied to a regeneration tower reboiler (corresponding to the reference sign 3 in FIG. 5) of the carbon dioxide recovery unit 10.

In this way, the low-pressure steam generated in the urea plant is used as a heat source for the carbon dioxide recovery unit, and the combustion exhaust gas is treated by the carbon dioxide recovery unit. In the present embodiment, the recovered carbon dioxide is transported to the outside of the plant for storage, and the like.

A description will now be given of whether it is feasible to recover carbon dioxide using thermal energy of the low-pressure steam supplied from the urea plant (specifically, feasibility of regeneration of the recovered solution by the regeneration tower in the carbon dioxide recovery unit) in the chemical plant of the present embodiment. Based on FIG. 1, a recovery amount of carbon dioxide, when the recovery rate of the carbon dioxide recovery unit is set to 90%, is 11.8 ton/h (corresponding to the line 22 in FIG. 1). According to Non Patent Literature 1, the energy required for separation and recovery of carbon dioxide is 3.2 GJ/ton-CO₂ (765 kcal/kg-CO₂). Thus, in the present embodiment, the required energy amount obtained from the recovery amount of the carbon dioxide is 37.8 GJ/h (9.03×10⁶ kcal/h).

In turn, the reboiler capacity which can be designed is calculated from the data of the low-pressure steam supplied through the line 33 from the urea plant 11 as follows: assuming that the low-pressure steam is condensed at 0.4 MPaG in the reboiler, the condensation latent heat is 2,133 kJ/kg (509.7 kcal/kg) and the steam flow rate is 18 t/h, hence 38.4 GJ/h (9.17×10⁶ kcal/h). Thus, the low-pressure steam supplied from the urea plant 11 is adequate as a heat source for the reboiler, and it is possible to recover carbon dioxide from combustion exhaust gas.

### Conventional Example

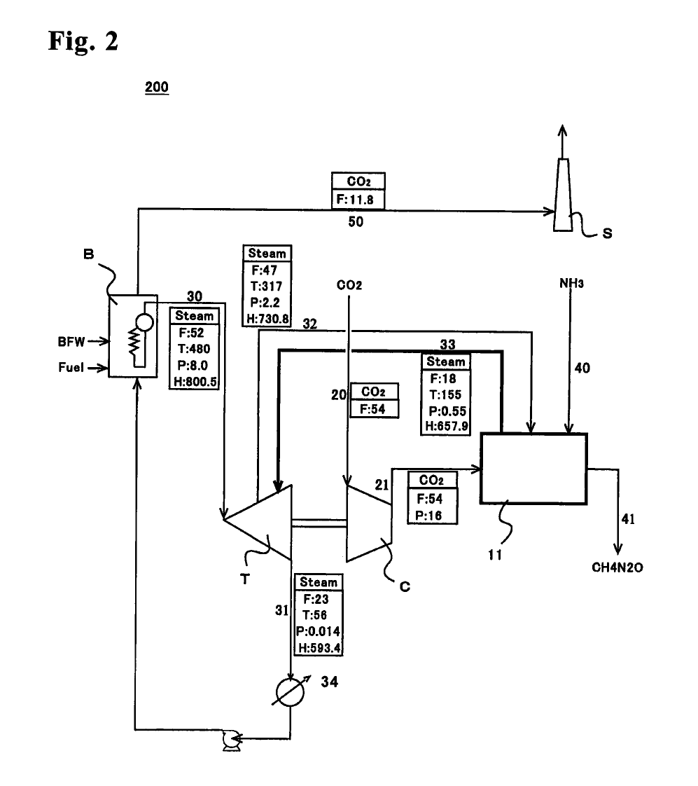

As a comparison to the chemical plant according to First Embodiment, FIG. 2 shows a configuration of a conventional chemical plant including a urea plant. A chemical plant 200 in this Conventional Example has the same production capacity of the urea plant as in First Embodiment. The equipment configuration is the same, and specifications of the boiler B, the steam turbine T, and the compressor C are also the same. In this Conventional Example, the low-pressure steam 33 generated in the urea plant 11 is treated by being admitted into the steam turbine T (admission steam).

Now, a comparison of energy loss of the low-pressure steam will be made between the chemical plants of First Embodiment and Conventional Example. In Conventional Example, the low-pressure steam 33 generated in the urea plant 11 is admitted into the steam turbine T, and as can be seen from the enthalpy of the steam 31 discharged from the turbine, the rate of utilization of the energy is about 15%. This means that, in Conventional Example, only about 15% of the low-pressure steam 33 generated in the urea plant 11 is used for driving the turbine, while the rest is turned into water by the condenser 34.

In contrast, in First Embodiment which utilizes the low-pressure steam 33 generated in the urea plant 11 as a heat source for the carbon dioxide recovery unit 10, the energy can be effectively used as described above. Thus, First Embodiment is deemed to be superior in terms of the effective use of the energy of low-pressure steam.

Next, a comparison will be made between First Embodiment and Conventional Example in terms of the reduction of carbon dioxide, which is the ultimate goal of the present application, on the basis of the carbon dioxide emission reduction energy penalty (kcal/kg-CO₂). First Embodiment utilizes the low-pressure steam generated in the urea plant and requires no new boiler for generating low-pressure steam for the carbon dioxide recovery unit 10. However, in First Embodiment, since the low-pressure steam generated in the urea plant is not admitted into the steam turbine, the flow rate of the steam generated by the existing boiler (line 30 in FIG. 1) needs to be higher than the flow rate of the steam generated by the existing boiler in Conventional Example (line 30 in FIG. 2) in order to increase the steam flow rate of the high-pressure steam to be supplied to the steam turbine.

A numerical value obtained by dividing the extra energy for generating this additional steam flow rate (58 t/h−52 t/h=6 t/h) by the carbon dioxide recovery amount corresponds to the carbon dioxide emission reduction energy penalty. This value is calculated as follows: 6000 kg/h (increase of steam flow rate)×800.5 kcal/kg (enthalpy difference between steam and water)÷0.8 (boiler efficiency)÷11,800 kg/h (CO₂ recovery amount)=approx. 477 kcal/kg-CO₂. This numerical value represents the carbon dioxide emission reduction energy penalty in First Embodiment.

On the other hand, when the same amount of carbon dioxide as in First Embodiment (11.8 t/h) is to be recovered by installing and operating the carbon dioxide recovery unit in Conventional Example, it is necessary to newly construct a boiler for supplying the heat source, and the energy equivalent to the fuel consumption of the boiler corresponds to the carbon dioxide emission reduction energy penalty.

According to Non Patent Literature 1, the energy amount required for separation and recovery of carbon dioxide to be taken into account is 3.2 GJ/t-CO₂ (765 kcal/kg-CO₂). Thus, if the carbon dioxide recovery rate and recovery amount equivalent to those in First Embodiment are to be achieved, the heat quantity of the regeneration tower reboiler is calculated as follows: 11,800 kg/h×765 kcal/kg-CO₂=9.03×10⁶ kcal/h. If this heat quantity is to be covered by the low-pressure steam and condensed at 0.4 MPaG as in First Embodiment, the required amount of the low-pressure steam is calculated as follows: 9.03×10⁶ kcal/h (heat quantity of regeneration tower reboiler)÷509 kcal/kg (condensation latent heat)=18 t/h. As to the heat balance in the boiler which generates this low-pressure steam of 18 t/h (18000 kg/h), in order to generate the low-pressure steam in the same conditions as in First Embodiment (saturated steam at 0.55 MPaG), the required fuel is calculated as follows: 18000 kg/h (steam generation amount)×(657.9 kcal/kg−50 kcal/kg) (enthalpy difference between steam and water)÷0.8 (boiler efficiency)=13.7×10⁶ kcal/h. Thus, the value obtained by dividing this required fuel amount by the carbon dioxide recovery amount, 13.7×10⁶ kcal/h÷11,800 kg/h=1160 kcal/kg-CO₂, is the carbon dioxide emission reduction energy penalty in Conventional Example.

On the basis of the above calculations, a comparison between the carbon dioxide emission reduction energy penalty in First Embodiment (approx. 477 kcal/kg-CO₂) and the carbon dioxide emission reduction energy penalty in Conventional Example (approx. 1,160 kcal/kg-CO₂) shows that First Embodiment has reduced the carbon dioxide emission reduction energy penalty by about 60% from Conventional Example. Thus, from the comparison based on the index of the carbon dioxide emission reduction energy penalty, First Embodiment is deemed to be a process involving less environmental load.

Further, First Embodiment increases the load on the existing boiler only to a minor extent, and requires no major modification. In contrast, Conventional Example requires new construction of a boiler, which contributes to increased environmental load and has a cost disadvantage.

### Second Embodiment

As another embodiment of the chemical plant of First Embodiment, Second Embodiment utilizes the carbon dioxide recovered by the carbon dioxide recovery unit as a raw material for the urea plant.

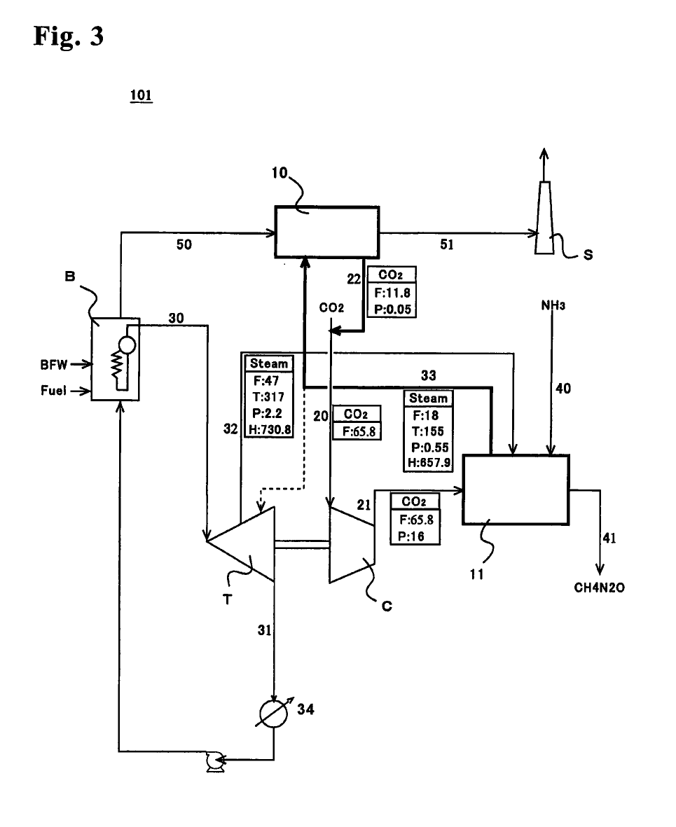

FIG. 3 illustrates a configuration of a chemical plant 101 of Second Embodiment. Each plant component and equipment configuration are basically the same as those in First Embodiment. In addition, the mass balance in each line is also the same as that in First Embodiment.

In the present embodiment, the carbon dioxide 22 recovered by the carbon dioxide recovery unit 10 is merged into the line 20 for the carbon dioxide supplied from the ammonia plant and pressurized by the compressor C. The carbon dioxide pressurized by the compressor C is supplied to the urea plant through the line 21.

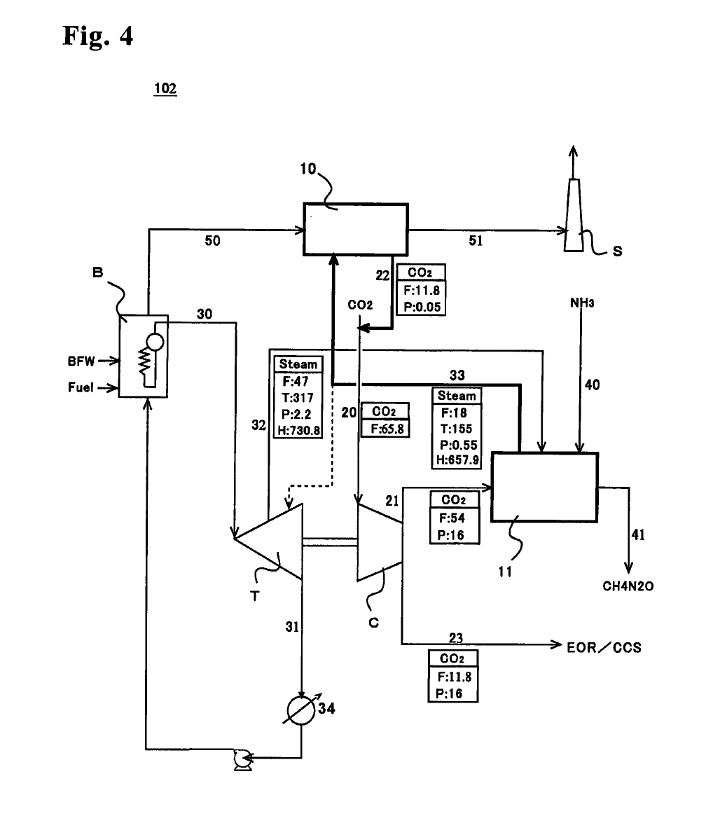

The line from the compressor C may be extended for other intended purposes. FIG. 4 shows a configuration of a chemical plant 102 which includes such extended line. This chemical plant 102 includes a line 23 from the compressor C, and the compressed carbon dioxide is supplied via the pipeline for transport/storage to the carbon dioxide storage facility and the EOR facility. Although not shown in FIG. 4, the line from the compressor C may be merged into a raw material supply line of another plant component which uses high-pressure carbon dioxide as a raw material.

This Second Embodiment pressurizes the recovered carbon dioxide with the existing compressor C and supplies the carbon dioxide to another facility, and is advantageous in that there is no need for adding a new compressor. The same is applied to a case where a chemical plant and a boiler exhaust carbon dioxide separation and recovery facility are newly installed.

Thus, as embodiments of the carbon dioxide recovery process according to the present invention, the case where the urea plant is used as a supply source of the low-pressure steam has been described. However, even when the urea plant is replaced with another plant component, such as an ammonia plant, a methanol plant, or a dimethyl ether plant, or when these plant components are added, the present invention can provide the effects of the improved utilization efficiency of the low-pressure steam energy and the reduction of the carbon dioxide emission reduction energy penalty.

### INDUSTRIAL APPLICABILITY

The present invention is a process for recovering carbon dioxide utilizing an absorbing solution circulating-type carbon dioxide recovery unit, and supplying a suitable heat source to the regeneration tower reboiler of the carbon dioxide recovery unit. The carbon dioxide recovery process according to the present invention improves the utilization efficiency of low-pressure steam from the existing plant component, of which the utilization efficiency has been conventionally low. In addition, the present invention effectively reduces the carbon dioxide emission reduction energy penalty. The process according to the present invention is applicable regardless of new plant or existing plant. It can be applied to a thermal power plant as well as to a chemical plant.

1. A process for recovering carbon dioxide in a plant which comprises at least one combustion unit combusting a carbon-containing fuel; a combustion exhaust gas line leading combustion exhaust gas from the combustion unit to flow through; and a carbon dioxide recovery unit installed in the combustion exhaust gas line, wherein the carbon dioxide recovery unit comprises an absorption tower for absorbing carbon dioxide into an absorbing solution; a regeneration tower for separating and recovering the carbon dioxide present in the absorbing solution from the absorption tower and circulating the treated absorbing solution to the absorption tower; and a reboiler for supplying steam to the regeneration tower, the plant has at least one plant component for discharging low-pressure steam at a pressure of 0.1 to 1 MPaG, and a line is installed for supplying the low-pressure steam from the plant component to the reboiler of the carbon dioxide recovery unit.

2. The process for recovering carbon dioxide according to claim 1, wherein the plant component for discharging the low-pressure steam is at least one of a urea plant, an ammonia plant, a methanol plant, and a dimethyl ether plant.

3. The process for recovering carbon dioxide according to claim 1, wherein the process supplies the carbon dioxide recovered by the carbon dioxide recovery unit to a raw material supply line of the plant component.

4. The process for recovering carbon dioxide according to claim 1, wherein the plant includes a turbine, and as the combustion unit, a boiler for generating steam for driving the turbine is provided.

5. The process for recovering carbon dioxide according to claim 1, wherein the plant includes a compressor, and the process compresses, with the compressor, the carbon dioxide recovered by the carbon dioxide recovery unit, and supplies the compressed carbon dioxide to the raw material supply line of the plant component.

6. The process for recovering carbon dioxide according to claim 1, wherein a urea plant and an ammonia plant are provided as the plant components discharging the low-pressure steam, the urea plant includes a compressor, and the process compresses, with the compressor, the carbon dioxide discharged from the ammonia plant, and supplies the compressed carbon dioxide to the urea plant.

7. The process for recovering carbon dioxide according to claim 6, wherein the process compresses, with the compressor, the carbon dioxide recovered by the carbon dioxide recovery unit, and supplies the compressed carbon dioxide to the urea plant.

8. The process for recovering carbon dioxide according to claim 1, wherein the plant includes a carbon dioxide transport or storage line connected to at least one of an enhanced oil recovery facility and an underground carbon dioxide storage facility.

9. The process for recovering carbon dioxide according to claim 8, wherein at least part of the carbon dioxide supplied to the transport or storage line is the carbon dioxide recovered by the carbon dioxide recovery unit.

10. The process for recovering carbon dioxide according to claim 8, wherein the plant includes a compressor, and the process compresses, with the compressor, the carbon dioxide to be supplied to the transport or storage line.

11. The process for recovering carbon dioxide according to claim 2, wherein the process supplies the carbon dioxide recovered by the carbon dioxide recovery unit to a raw material supply line of the plant component.

12. The process for recovering carbon dioxide according to claim 2, wherein the plant includes a turbine, and as the combustion unit, a boiler for generating steam for driving the turbine is provided.

13. The process for recovering carbon dioxide according to claim 3, wherein the plant includes a turbine, and as the combustion unit, a boiler for generating steam for driving the turbine is provided.

14. The process for recovering carbon dioxide according to claim 11, wherein the plant includes a turbine, and as the combustion unit, a boiler for generating steam for driving the turbine is provided.

15. The process for recovering carbon dioxide according to claim 2, wherein the plant includes a compressor, and the process compresses, with the compressor, the carbon dioxide recovered by the carbon dioxide recovery unit, and supplies the compressed carbon dioxide to the raw material supply line of the plant component.

16. The process for recovering carbon dioxide according to claim 3, wherein the plant includes a compressor, and the process compresses, with the compressor, the carbon dioxide recovered by the carbon dioxide recovery unit, and supplies the compressed carbon dioxide to the raw material supply line of the plant component.

17. The process for recovering carbon dioxide according to claim 11, wherein the plant includes a compressor, and the process compresses, with the compressor, the carbon dioxide recovered by the carbon dioxide recovery unit, and supplies the compressed carbon dioxide to the raw material supply line of the plant component.

18. The process for recovering carbon dioxide according to claim 4, wherein the plant includes a compressor, and the process compresses, with the compressor, the carbon dioxide recovered by the carbon dioxide recovery unit, and supplies the compressed carbon dioxide to the raw material supply line of the plant component.

19. The process for recovering carbon dioxide according to claim 12, wherein the plant includes a compressor, and the process compresses, with the compressor, the carbon dioxide recovered by the carbon dioxide recovery unit, and supplies the compressed carbon dioxide to the raw material supply line of the plant component.

20. The process for recovering carbon dioxide according to claim 13, wherein the plant includes a compressor, and the process compresses, with the compressor, the carbon dioxide recovered by the carbon dioxide recovery unit, and supplies the compressed carbon dioxide to the raw material supply line of the plant component.
